(19) United States
(12) Patent Application Publication
(10) Pub. No.: US 2004/0083192 A1
(43) Pub. Date: Apr. 29, 2004

(54) High availability link testing device

(76) Inventor: Stephen J. Elliott, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/282,624

(22) Filed: Oct. 29, 2002

(51) Int. Cl. G06E 1/00

(52) U.S. Cl. 706/26

(57) ABSTRACT

An apparatus for testing devices for use in high availability systems provides simulation of high availability failures using hardware events and independent of the operating process. The apparatus includes a plurality of inputs each having an evaluation component associated therewith. A controller and power supply is also provided for controlling operation of the evaluation components. A degeneration component allows for degeneration of a link.

### FIELD OF THE INVENTION

The present invention relates generally to systems and processes for testing devices communicating via data links, and more particularly to a hardware implemented system for testing the high availability properties of high availability devices communicating via data links.

### BACKGROUND OF THE INVENTION

High availability systems include devices and components that are typically required to operate continuously and/or for extended periods of time (e.g., months). In such high availability systems, an availability standard of greater than 99.9% is often desirable. Computer systems and/or networks are constructed of many component parts that typically must function in order for the entire system to be operational. Thus, in order to reduce the likelihood of failure of a particular device, extensive planning and testing is required of the various component parts of the system. This may include, for example, planning to provide backup systems and testing to determine the effects of device or data link failures, including ensuring data access and data storage.

Extensive testing of devices to be used in a high availability system reduces the likelihood that the device will become a point of failure. When designing and building equipment and systems, particularly high availability systems requiring continuous high data rate transfers, it is typically important to ensure that the equipment meets all applicable requirements and qualification tests to reduce the likelihood of device failure, which may result in overall system failure. For example, hazard tests may be performed that test the number or reads and writes for a disk, as well as disk mounts and unmounts to test overall system reliability. Software simulation tests may also be provided to simulate link failure during a hazard test. Further, logical volume manager failure tests and upper level software tests for testing entire SAN solutions may be provided to determine overall system reliability under different failure modes.

It is typically important not only to test the operation of the entire system, but to determine the operating characteristics and possible points of failure within the system. For example, it may be desirable to add artificial jitter to a system to simulate a cabling problem, system problem or link problem. This allows for troubleshooting of the system and/or of a particular device (e.g., data switch) before finalizing or completing design and construction.

Known systems providing such testing and troubleshooting perform system and/or device power up and power down to simulate total failure of the system and/or device using software. Further, simulating a link failure using software may be provided. This testing is limited to particular failures that are simulated using software processes.

As recognized by the inventor hereof, it is desirable to provide an automated hardware implemented system for testing devices for use in high availability systems. Such a system should provide for simulating link-down events that are independent of the operating process within the system and independent of a particular protocol layer. Further, the ideal link used for simulation should be a worst-case failure and should test hardware transients at power on and power off.

### SUMMARY OF THE INVENTION

The present invention includes a high availability link testing device that provides automated hardware simulation of system failures (e.g., a down-link) to test components and/or devices for use in high availability systems. The simulated failures, and in particular, simulated link failures, provide worst-case testing.

In one embodiment of the present invention, an apparatus providing high availability testing includes means for connecting devices thereto to provide a link therebetween and means for simulating high availability failures independent of an operating process to thereby provide high availability testing. The means for simulating may be hardware implemented and the hardware failures may include a link-down event and/or jitter.

In another embodiment of the present invention an apparatus providing high availability testing includes a plurality of connection members for connecting devices thereto for high availability testing, a plurality of evaluation components, each associated with one of the plurality of connection members and a controller for controlling the evaluation components and configured to simulate high availability failures for use in high availability testing. The apparatus may include a host controller for executing a script to provide the simulation. The high availability failures may include link-down events and/or jitter.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1(a) and 1(b) are block diagrams of an exemplary high availability system having devices in connection with which the present invention may test;

FIG. 2 is a block diagram showing a link between two devices in a high availability system;

FIG. 3 is a simplified block diagram of a high availability link testing device of the present invention connected to devices to be tested;

FIG. 4 is a simplified block diagram of a high availability link testing device of the present invention showing device links;

FIG. 5 is a detailed block diagram of one embodiment of a high availability link testing device of the present invention;

FIG. 6 is a detailed block diagram of another embodiment of a high availability link testing device of the present invention having degeneration components;

FIG. 7 is a block diagram of another embodiment of a high availability link testing device of the present invention having a separate power module for each evaluation component; and

FIG. 8 is a block diagram showing an exemplary configuration for testing a JBOD using a high availability link testing device of the present invention.

### DETAILED DESCRIPTION OF THE PREFERRED EMBODIMENTS

The following description of the preferred embodiments is merely exemplary in nature and is in no way intended to limit the invention, its application, or uses. Thus, although the present invention is described in connection with a system having particular component parts for testing devices for use in high availability systems, it is not so limited, and different or additional component parts may be implemented for testing the devices.

Before describing a high availability link testing device of the present invention, a high availability system having devices connected thereto in connection with which the present invention may provide testing will be described. Thereafter a detailed description of the construction and operation of a high availability link testing device of the present invention will be provided.

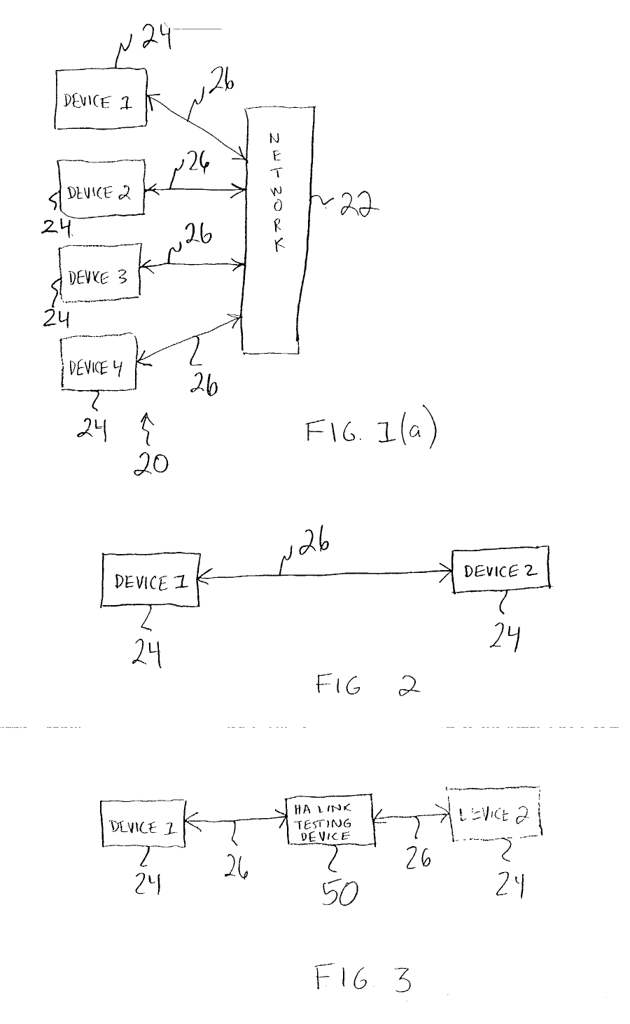

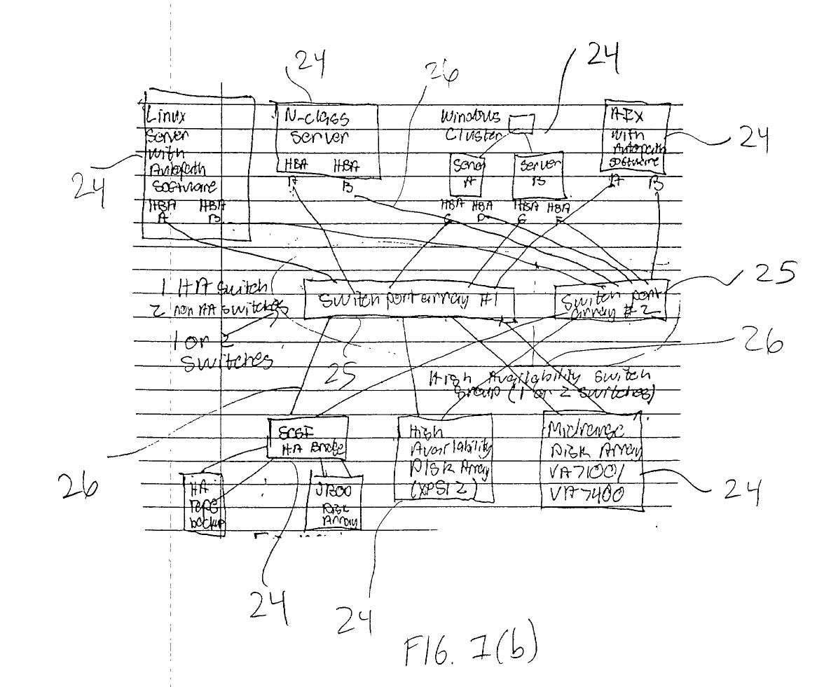

In general, and as shown in FIGS. 1(a) and 1(b), an exemplary high availability system 20, may include, for example, a computer system or network 22 providing communication and control between a plurality of devices 24 (e.g., HA disk array, midrange disk array, SCSI HA bridge, N-class server, Linux server, etc.). In particular, communication between the devices 24 is provided by data links 26 connecting the devices 24, which may include a switch or switch port array 25 to direct data traffic. In such a high availability system 20, the devices 24 are typically required to operate continuously or for extended periods of time without a failure. More particularly, failure of any device 24 may result in failure of the overall high availability system 20. Thus, as shown in FIG. 2, continuous connection between devices 24 via data links 26 is needed to ensure proper operation of the high availability system 20.

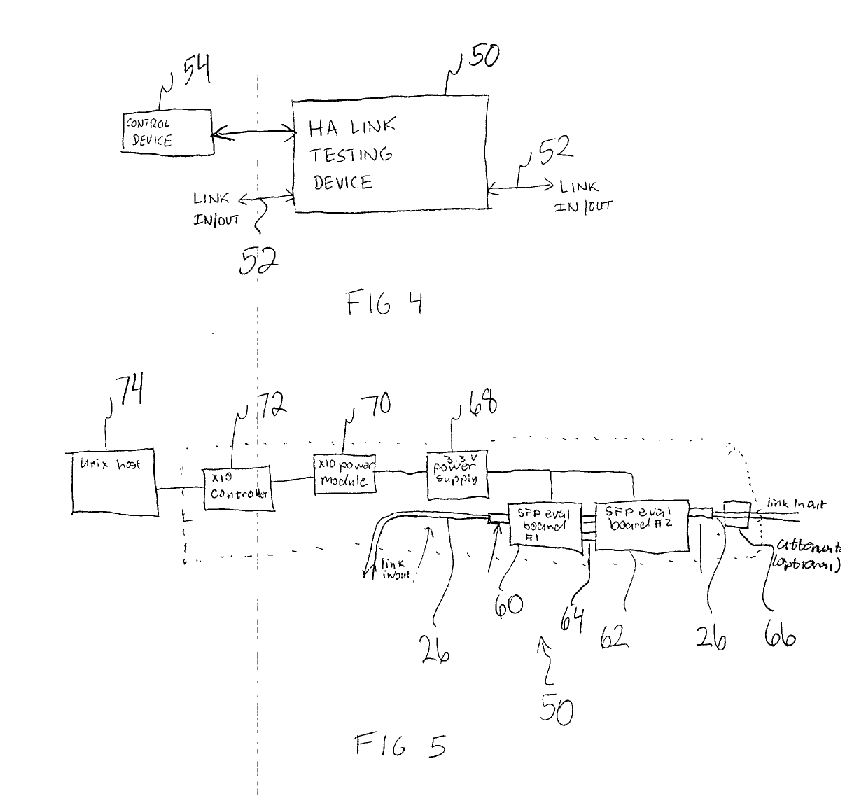

Having generally described a high availability system 20, one embodiment of a high availability (HA) link testing device 50 of the present invention as shown in FIGS. 3 and 4, allows for connection of devices 24 thereto and testing thereof (e.g., introduction of jitter into the links 26 to test effects on the device 24). The HA link testing device 50 includes a plurality of input/output links 52 for connection of devices 24 thereto. Further, a control device 54 is provided in connection with the HA link testing device 50 for controlling the devices 24 connected thereto and simulating failure of high availability conditions (e.g., link failure).

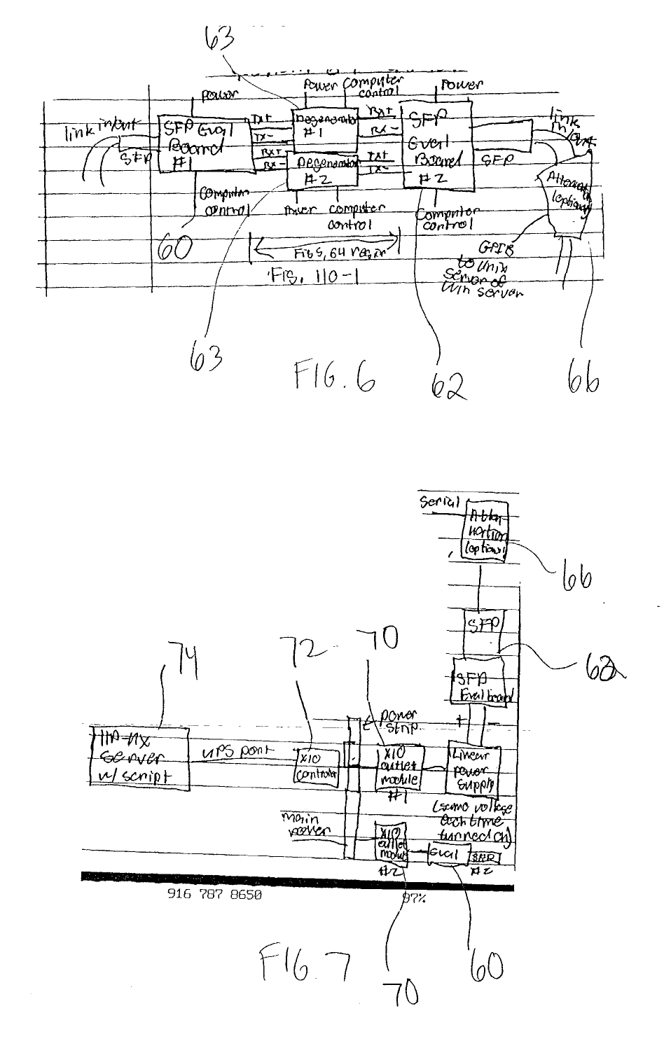

More particularly, and as shown in FIG. 5, one embodiment of the HA link testing device 50 generally includes a first small form-factor pluggable (SFP) evaluation component 60 (e.g., SFP evaluation board) providing connection to a device 24 via a data link 26 (e.g., optical fibre link) and a second SFP evaluation component 62 (e.g., SFP evaluation board) providing connection to another device 24 via a data link 26. It should be noted that an attenuation unit 66 may be provided in connection with one or more of the data links 26 to amplify data signals communicating via the data links 26.

The first and second SFP evaluation components 60 and 62 are preferably connected together via small male adapter (SMA) connections 64. Further, in another embodiment, one or more degeneration components 63 (e.g., degeneration board) may be provided between the SFP evaluation components 60 and 62 as shown in FIG. 6. The degeneration components 63 are configured to degrade the electrical signal in a controlled manner using modulated jitter or ISI jitter from a low-pass filter having several inches of circuit trace. The degeneration component may be provided such as described in co-pending U.S. application Ser. No. 09/766,903 entitled “Digital Data Pattern Detection Methods and Arrangements” filed on Jan. 18, 2001, the entire disclosure of which is incorporated herein by reference. Preferably, a computer control is provided to control the jitter and coordinate tasks based upon the devices to be tested.

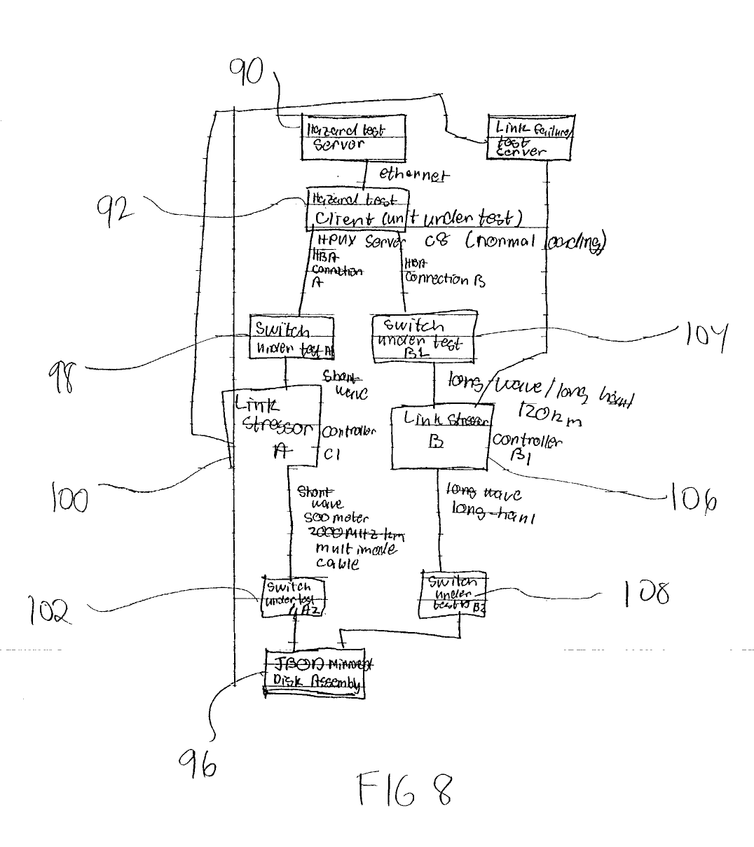

A power supply 68 (e.g., 3.3 volt power supply) is provided to power the first and second SFP evaluation components 60 and 62. A power module 70 (e.g., X10 power module) in combination with a power controller 72 (e.g., X10 controller) are provided to control the power supply 68. The power controller 72 using the power module 70 controls the power supply 68 that powers the SFP evaluation components 60 and 62. The power controller 72 provides for turning on and off the power supply 68, which turns on and off the optical output from the SFP evaluation components 60 and 62, thereby turning on and off the link as shown n FIG. 7. It should be noted that as shown therein a separate power module 70 may be provided in connection with each of the SFP evaluation components 60 and 62. Further, the power module 70, and in particular, the X10 power module, and power controller 72, and in particular, the X10 controller, may be of the type available from Radio Shack.

A host controller 74 (e.g., UNIX controller) is further connected to the power controller 72 to provide external control of the power supply 68. In particular, a separate UNIX server provides independence in the timing of the on and off events or signal degradation from the system clocks of the devices being tested. A script preferably runs on the host controller 74 that is not part of the set of devices being tested.

More specifically, and with respect to the component parts of the HA link testing device 50, the SFP evaluation components 60 and 62 are configured to receive differential signals and convert the SMA-based electrical signal to a single-ended optical SFP-based signal when the SFP is under evaluation. The SFP evaluation components 60 and 62 also provide for computer control and test access points to power, ground, as well as other signals needed for computer control. The SFP evaluation components 60 and 62 may be provided for short wave (e.g., up to 300 meters at 2 Gb/s) or long wave (e.g., from 300 meters to ten kilometers at 2 Gb/s) operation. Any suitable SFP board may be implemented to provide the SFP evaluation components 60 and 62, such as are available from, for example, IBM, Finisar, Agilent, and Methode.

The SMA connections 64 are preferably coaxial cables that introduce a defined amount of jitter per unit length. Thus, by selecting an appropriate length of SMA coaxial cable, a predetermined amount of jitter may be introduced (e.g., margin degradation). For example, if 200 picoseconds (psec) of jitter margin is desired at a nominal temperature to account for manufacturing variations, temperature variations and the effects of a full 6 dB optical attenuation, then data can be collected from a graph of jitter tests showing picoseconds of jitter versus cable length. An appropriate cable length for introducing a specified amount of jitter may then be provided.

Thus, the present invention provides an HA link testing device 60 for connecting devices 24 thereto and simulating high availability failures, such as, for example, problems (e.g., jitter) or system failures (e.g., down-link). The HA link testing device 60 can, for example, degenerate the link and introduce link-down and up events. This may include degenerating the link (e.g., optical link) to simulate a worst-case situation for HA testing. Further, and for example, link margins between devices 24 may be tested and verified without the need for large lengths of cabling because ISI can be introduced electronically by using short dispersion-generating electrical cable and the attenuation unit 66 as described herein.

In one embodiment of the present invention, a script provides commands to the X10 controller 72, for example, at the UNIX level, for controlling the X10 controller 72 using the host controller 74, in this case a UNIX host. For example, in one exemplary embodiment, the script may be provided as follows:

```
while true
do
        x10 turn c5 off
        sleep 300
        x10 turn c5 on
        sleep 300
        attenuate #New command that sets the attenuation if
        incorporated
        sleep 300
        strengthen #New command to remove attenuation if attenuation
          incorporated
        sleep 300
done
```

Using the script in connection with the HA link testing device 60, a simulated link failure may be provided applying worse-case conditions. Specifically, the “while true . . . do” commands form an infinite loop on a test sequence to maximize exposure to worst case conditions. The “x10 turn c5 off” command turns off the power controller 72, and in particular, the X10 controller with a selected address, to simulate a link failure. The “sleep 300” command delays turning the unit off for five minutes. The “x10 turn c5 on” command simulates reestablishment of the link after five minutes of link failure. The “attenuate” command is a GPIB or serial interface script or program that would set the optional attenuator 66 to a worst case attenuation to test for sufficient optical power margin. The “sleep 300” exposes the system under test to diminished optical budget for five minutes. The “strengthen” command is a GPIB or serial interface script or program on a separate server (e.g., host controller 74) that establishes the original optical conditions. The “sleep 300” command again provides a five minute delay and the “done” command ends the script.

It should be noted that different scripts may be provided depending upon the simulation desired or needed and the devices connected to the HA link testing device 60. The script described above is merely exemplary. For example, the script may be written to operate using a different host controller 74 or simulate various types of system problems or system failures. Further, a similar script may be written in, for example, a visual programming language.

In operation, the HA link testing device 60 may provide for testing of devices to allow, for example, for qualification of a device 24 with respect to specific standards or requirements. For example, a Simulated Link Interrupt Test (SLIM) test may be provided using the HA link testing device 60 and as shown in FIG. 8. Specifically, a hazard test server 90 networked with a hazard test client 92 (e.g., via an Ethernet) executes hazard test software to simulate heavy, but normal traffic load by selecting an appropriate option on the hazard server 90. The hazard test client 92 keeps track of the success of read and write operations utilizing, for example, logical volume PVLINKS software or Autopath software both available from Hewlett-Packard Company, and corrects for link failures by redirecting data traffic from a primary to a secondary path. The test is performed for a minimum predetermined period of time (e.g., at least twenty-four hours).

A JBOD 96 being tested may include, for example, ten disks, with two channels to access each disk. Thus, for example, five disks may be selected to have the primary PVLINKS as Link A using Switch A1 98, Link Stressor A 100, Switch A2 102, Link to target and link to HBA card. The other five disks may be selected to have the primary PVLINKS as Link B using Switch B1 104, Link Stressor B 106, and Switch B2 108, Link to target and link to HBA card. The use of separate links will allow for testing both short wave and long wave technologies in the same setup.

To implement a link failure test of the JBOD 96, the hazard test server 90 may execute the following script to fail the primary A paths and then reestablish the primary A paths with attenuation:

| | |
|---|---|
| while true | |
| do | |
| x10 turn c1 on | |
| x10 turn B1 off | |
| sleep 300 | |
| x10 turn B1 on | |
| sleep 300 | |
| attenuate B | # Attenuate B Channel |
| sleep 300 | |
| strengthen B | # Reestablish B Channel |
| sleep 300 | |
| x10 turn c1 off | |
| sleep 300 | |
| x10 turn c1 on | |
| sleep 300 | |
| attenuate C | # Attenuate C Channel |
| sleep 300 | |
| strengthen C | # Reestablish C Channel |
| sleep 300 | |
| date | #Coordinate time stamp with hazard |
| done | |

Using this script a failure and attenuation of the optical link can be caused. In this example, the cabling is selected to provide 100 psec margin on ISI jitter to account for performance variations over temperature. Further, the degeneration components 63 may be set to introduce variable jitter from 50 psec to 300 psec to identify how much jitter margin is available on the system.

Thus, the present invention provides a high availability link testing device that allows for automated hardware simulation of system failures (e.g., down-link) to test components and/or devices for use in high availability systems. The simulated failures, including for example, simulated link failures, may provide worst-case testing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus providing high availability testing, the apparatus comprising:
means for connecting devices thereto to provide a link therebetween; and
means for simulating a high availability failure independent of an operating process to thereby provide high availability testing.

2. The apparatus according to claim 1 wherein the means for simulating are hardware implemented.

3. The apparatus according to claim 1 wherein the high availability failure comprises a link-down event.

4. The apparatus according to claim 1 wherein the high availability failure comprises jitter.

5. The apparatus according to claim 1 further comprising means for attenuating the link.

6. The apparatus according to claim 1 wherein the means for simulating is configured to provide optical link testing.

7. An apparatus providing high availability testing, the apparatus comprising:
a plurality of connection members for connecting devices thereto for high availability testing;
a plurality of evaluation components, each associated with one of the plurality of connection members; and
a controller for controlling the evaluation components and configured to simulate a high availability failure for use in high availability testing.

8. The apparatus according to claim 7 further comprising a power supply for powering the plurality of evaluation components.

9. The apparatus according to claim 7 further comprising an attenuation component in connection with at least one of the connection members.

10. The apparatus according to claim 7 further comprising a host controller for executing a script to provide the simulation.

11. The apparatus according to claim 10 wherein the host controller comprises a UNIX host for executing a script for performing UNIX commands.

12. The apparatus according to claim 7 wherein the plurality of evaluation components comprise SFP evaluation boards.

13. The apparatus according to claim 12 wherein the SFP evaluation boards are connected together using SMA connections.

14. The apparatus according to claim 7 wherein the controller comprises an X10 controller.

15. The apparatus according to claim 13 wherein the controller comprises an X10 power module.

16. The apparatus according to claim 7 the high availability failure comprises link-down events.

17. The apparatus according to claim 7 the high availability failure comprises jitter.

18. The apparatus according to claim 7 wherein the plurality of connection members comprise optical fibre links.

19. The apparatus according to claim 9 wherein the plurality of connection members comprise dispersion-generating electrical cable.

20. The apparatus according to claim 7 wherein the controller is configured to simulate a worst case high availability failure.

21. The apparatus according to claim 7 further comprising a degeneration component.

22. A method of testing devices for use in high availability systems, the method comprising:
connecting a plurality of devices together for testing; and
simulating high availability failures using hardware events to provide high availability testing of the connected devices and independent of an operating process.

23. The method according to claim 22 wherein the simulating comprises simulating a link-down event.

24. The method according to claim 22 wherein the simulating comprises simulating jitter.

25. The method according to claim 22 further comprising determining link margins between the devices using the simulating.
